(19) United States
(12) Patent Application Publication
(10) Pub. No.: US 2014/0046899 A1
(43) Pub. Date: Feb. 13, 2014

(54) Method and Apparatus of Implementing Navigation of Product Properties

(71) Applicant: Alibaba Group Holding Limited, Grand Cayman (KY)

(72) Inventors: Changlong Sun, Hangzhou (CN); Anxiang Zeng, Hangzhou (CN)

(73) Assignee: Alibaba Group Holding Limited, Grand Cayman (KY)

(21) Appl. No.: 13/960,594

(22) Filed: Aug. 6, 2013

(30) Foreign Application Priority Data
Aug. 7, 2012 (CN) 201210279159.2

(51) Int. Cl. G06F 17/30

(52) U.S. Cl. CPC G06F 17/30306
USPC 707/609

(57) ABSTRACT

The present disclosure provides techniques for commodity property navigation. These techniques may determine, by a computing device, current corresponding property information of any product node in a product information database, and corresponding property information of each commodity under the product node. The computing device may add the property information to be updated into the current corresponding property information of the product node when property information to be updated exists. The computing device may then perform commodity property navigation by using the updated current corresponding property information of the product node. Using techniques of the present disclosure, mining and navigation of novel commodity properties may be implemented automatically, therefore solving problems (e.g., failure for timely updating commodity properties) associated with existing techniques.

### CROSS REFERENCE TO RELATED PATENT APPLICATIONS

This application claims priority to Chinese Patent Application No. 201210279159.2, filed on Aug. 7, 2012, entitled “Method and Apparatus of Implementing Navigation of Product Properties,” which is hereby incorporated by reference in its entirety.

### TECHNICAL FIELD

The present disclosure relates to the technical field of the Internet and, more specifically, to commodity property navigation.

### BACKGROUND

With continuous development of Internet technology, online shopping becomes more and more popular in daily life. Users generally browse commodity information provided by sellers on websites for online shopping. Since commodity information includes mass information, navigation of such information is challenging. This demands technologies to help users to accurately and quickly find desired commodities.

Generally, navigation of commodities is classified into category navigation and property navigation. Category navigation refers to navigation based on a category system. For example, the category system is represented by a dendritical structure. Each parent category includes a plurality of sub-categories. Distances among categories become smaller and smaller from top to bottom. A leaf node is called a leaf category. FIG. 1 illustrates a category system. As illustrated, FIG. 1 includes categories “physics” and “chemistry” that are leaf categories, while “natural science” is a parent category of the leaf categories “physics” and “chemistry.” Meanwhile, both “natural science” and “social science” are sub-categories of parent category, i.e., “books.” Users can browse the books related to physics or chemistry by clicking the navigation of “physics” or “chemistry.” In other words, users perform category navigation by using the “physics” or “chemistry” category information of the book product.

Similar to the category navigation, property navigation refers to navigation based on property information of commodities under categories in a category property system. The property information of commodities includes commodity properties for representing commodity dimensions and corresponding property values of the commodity properties. The category property system may also be represented via a dendritical structure. Since commodity properties and commodity property values are used for classifying commodity information, a certain correlation exists among the categories, commodity properties and commodity property values. In general, one leaf category may generally correspond to a plurality of commodity properties. For example, under the leaf category “physics” shown in FIG. 1, a plurality of commodity properties representing “physics” dimensions may exist such as “author”, “publication time”, “publisher”, etc. Meanwhile, a plurality of commodity property values may exist under each commodity property. For example, a plurality of commodity property values, such as “publisher A”, “publisher B”, “publisher C”, etc., may exist under the commodity property ““publisher”. Therefore, as shown in FIG. 2, a structural schematic diagram of the category property system may be obtained. Users can browse the books related to publisher A or publisher B by clicking the navigation of “publisher A” or “publisher B.” In other words, users perform commodity property navigation by using the “publisher A” or “publisher B” property information of the book product.

Under the category navigation, even though commodity information is classified based on a coarse granularity in categories, the commodity information within leaf category in a bottom-most layer in the category system is still mass information. Accordingly, users still need to spend a lot of time to find desired products, resulting in low efficiency.

Compared with the category navigation, the property navigation is used for further classifying commodity information based on a finer granularity associated with categories. Each property includes a small amount of information so that an amount of navigation commodity information provided to users may be reduced, therefore increasing efficiency of the navigation.

Under current technologies, property navigation requires personnel to review manually, and thus certain novel properties of commodities cannot be found or updated by operating personnel in time. Thus causing low user experience and leading to low navigation efficiency.

### SUMMARY

Embodiments of the disclosure relate to methods and systems for commodity property navigation to solve problems (e.g., low navigation efficiency and failure for timely updating product information) associated with the current technologies.

In some embodiments, a method may include, for any product node in a product information database, determining, by a computing device, current corresponding property information of the product node and corresponding property information of each commodity under the product node. The product node may be obtained by grouping commodities belonging to the same category and having the same key property information according to key property information in corresponding property information of each commodity in the commodity information database and a category to which corresponding property information of each commodity belongs. When the property information to be updated exists, the computing device may add the property information to be updated into the current corresponding property information of the product node. The property information to be updated may be included in corresponding property information of at least one commodity under the product node but not comprised in the current corresponding property information of the product node. The computing device may then perform commodity property navigation by using the current corresponding property information of the updated product node.

In some embodiments, a computing device for commodity property navigation may include a property information determining module configured to determine the current corresponding property information of any product node in a product information database and the corresponding property information of each commodity under the product node for the product node. The product node may be obtained by clustering commodities belonging to the same category and having the same key property information according to key property information in corresponding property information of each commodity in the commodity information database and a category to which corresponding property information of each commodity belongs. The computing device may also include a property information updating module configured to add the property information to be updated into the current corresponding property information of the product node when property information to be updated exists. The property information to be updated may be included in corresponding property information of at least one commodity under the product node but not comprised in the current corresponding property information of the product node. The computing device may also include a commodity property navigation module configured to perform commodity property navigation by using the current corresponding property information of the updated product node.

When the computing device determines that the presence of property information to be updated exists in corresponding property information of each commodity under any product node in the product information database, the computing device may add the property information to be updated into the current corresponding property information of the product node. Then, commodity property navigation may be performed by using the current corresponding property information of the updated product node. The property information to be updated may be included in corresponding property information of at least one commodity under the product node but not comprised in the current corresponding property information of the product node. Via the technical scheme of the embodiments of the disclosure, mining and navigation of novel commodity properties may be realized automatically, and the problems associated with the current technologies may be solved.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 is a structural schematic diagram of the category system under currently technologies.

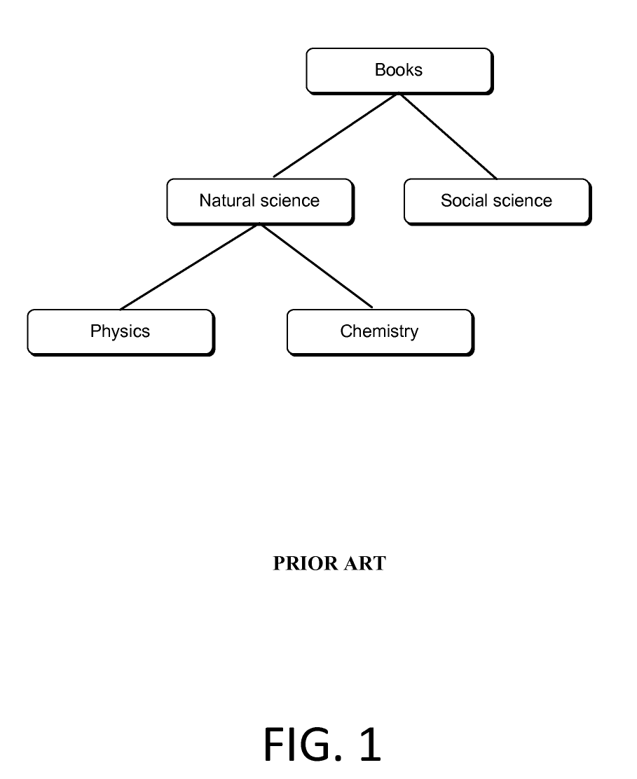

FIG. 2 is another structural schematic diagram of the category property system under currently technologies.

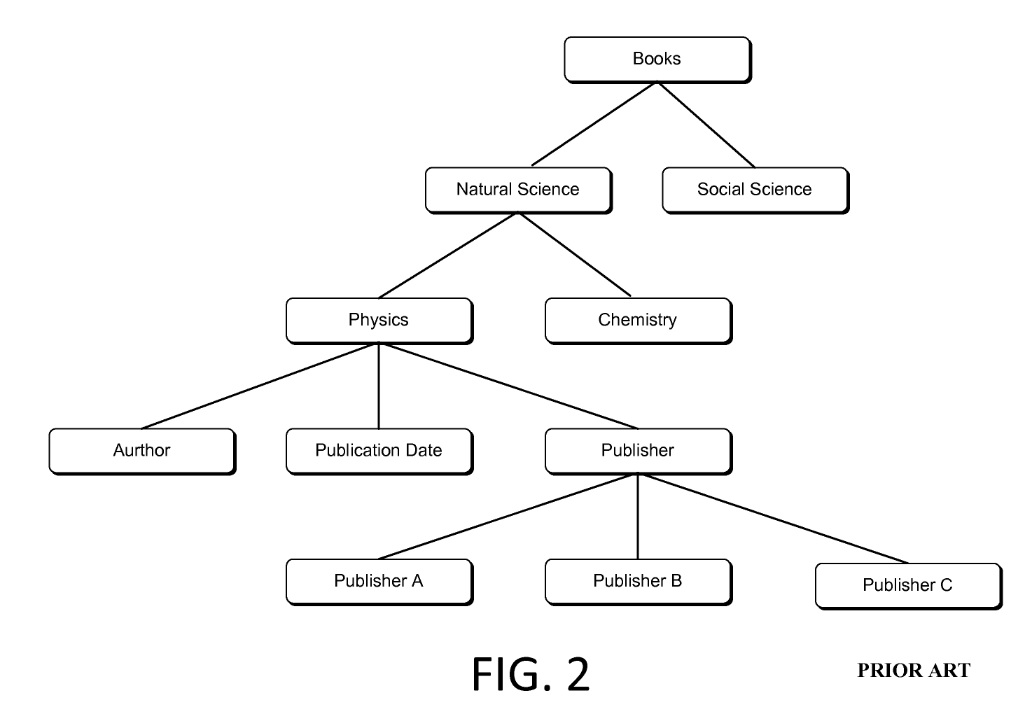

FIG. 3 is a flow chart of an illustrative process for commodity navigation.

FIG. 4 is a flow chart of an illustrative process for updating commodity property information associated with commodity navigation.

FIG. 5 is a schematic diagram of an illustrative computing architecture that enables commodity navigation.

### DETAILED DESCRIPTION

Embodiments of the disclosure provide methods and systems for commodity property navigation. In some embodiments, a method for commodity property navigation may include, for any product node in a product information database, determining, by a computing device, current corresponding property information of the product node and corresponding property information of each commodity under the product node. When property information to be updated exists, the computing device may add the property information to be updated into the current corresponding property information of the product node, and perform commodity property navigation by using the current corresponding property information of the updated product node. The product node may be obtained by grouping commodities belonging to the same category and having the same key property information according to key property information in corresponding property information of each commodity in the commodity information database and a category to which corresponding property information of each commodity belongs. The property information to be updated may be included in corresponding property information of at least one commodity under the product node but not comprised in the current corresponding property information of the product node. Via the technical scheme of the disclosure, mining and navigation of novel commodity properties may be realized automatically, and problems (e.g., poor navigation efficiency and failure for timely updating commodity property information) are solved.

Embodiments of the disclosure are further described by taking the embodiments in conjunction with the accompanying drawings below, but the disclosure is not limited to the exemplified embodiments described below.

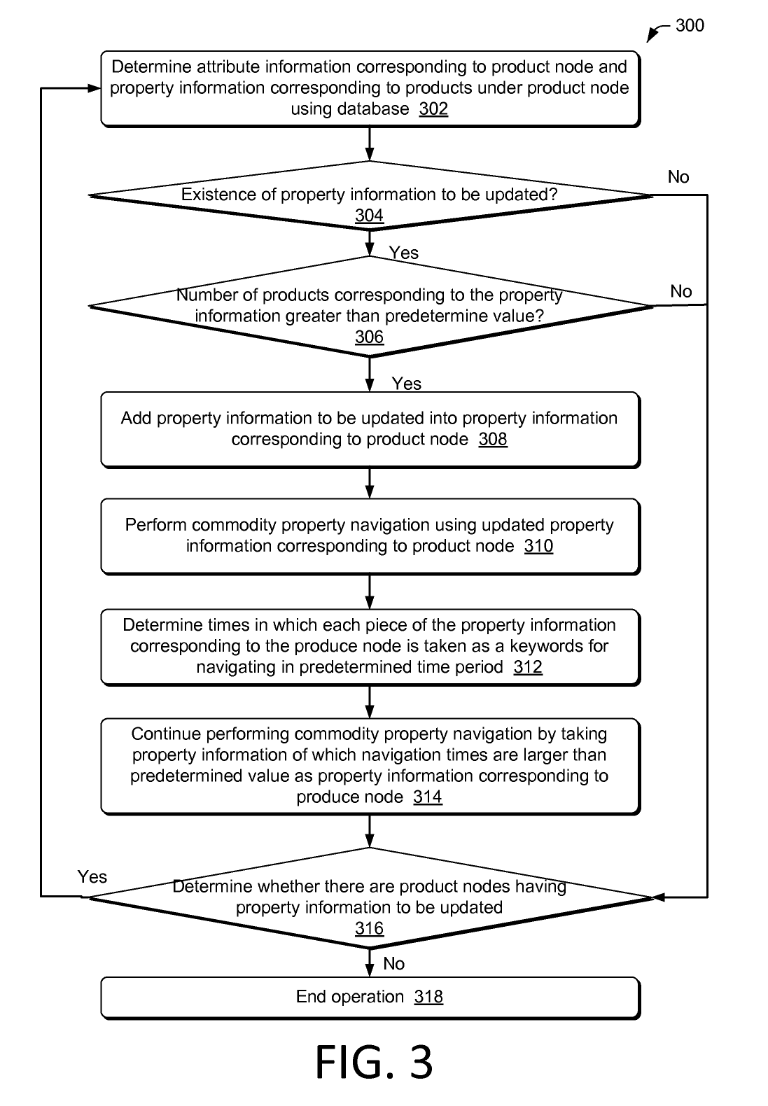

FIG. 3 is a flow chart of an illustrative process for commodity navigation. At 302, the computing device may, for any product node which does not undergo judgment on the presence of property information to be updated currently in a product information database, determine current corresponding property information of the product node and corresponding property information of each commodity under the product node. In some embodiments, the product node may be obtained by clustering commodities belonging to the same category and having the same key property information according to key property information in corresponding property information of each commodity in the commodity information database and a category to which corresponding property information of each commodity belongs. The key property information may include property information capable of identifying commodity characteristics; for any product node, corresponding property information (e.g., key property information) of the product node may reflects shared information of the same type of commodities. In these instances, the product information database may include at least one product node.

In some embodiments, corresponding property information of each commodity in the commodity information database may be obtained by adopting the following two measures. First, the computing device may acquire commodity property information by adopting a Feed way. In this measure, filling or entering of commodity property information is performed by the commodity supplier, and the integrity and accuracy of the obtained commodity property information are high. Second, the computing device may acquire commodity property information by adopting a Crawl way. In this measure, commodity property information may be obtained by crawling commodity information from each Internet website and automatically extracting property information from crawled commodity information according to a pre-configured property information template. Compared with measure I, the integrity and accuracy of the obtained commodity property information using measure II are lower.

In some embodiments, the property information may include properties and property values. For a product node, corresponding property information of the product node may include the properties of the product node and property values of the product node corresponding to the properties of the product node; and for any commodity. In addition, the property information of the commodity may include the property of the commodity and the property value of the commodity corresponding to the property of the commodity.

Furthermore, the product node may be obtained by clustering commodities belonging to the same category and having the same key property information according to key property information in corresponding property information of each commodity in the commodity information database and a category to which corresponding property information of each commodity belongs.

For example, for a book type commodity, suppose that a product node M is “a physics book of which the International Standard Book Number (ISBN) is 1010 and “publication time is 2000-2010.” It may be assumed that the product node M is obtained by clustering commodities having property information, i.e., “ISBN is 1010” and “publication time is 2000-2010” and belonging to the category “physics”; specifically, the property information, i.e., “ISBN is 1010” and “publication time is 2000-2010” includes properties, i.e., “ISBN” and “publication time” and two property values, i.e., “1010” and “2000-2010” corresponding to the two properties, i.e., “ISBN” and “publication time” respectively. As results, “ISBN” is the key property of the same type of commodities represented by the product node M.

Furthermore, in the operation 302, the current corresponding property information of the product node M determined according to the product node M is “ISBN is 1010” and “publication time is 2000-2010”; specifically, the current corresponding properties of the product node M determined according to the product node M are “ISBN” and “publication time”, and determined corresponding property values of the current corresponding properties, i.e., “ISBN” and “publication time” of the product node M are “1010” and “2000-2010” respectively.

Furthermore, suppose that the product node M specifically includes physics book commodities A having property information such as “ISBN is 1010, publication time is 2000-2010, author is B, price is 10-50” etc., physics book commodities B having property information such as “ISBN is 1010, publication time is 2000-2010, price is 10-50, hardcover bookbinding is adopted” etc., physics book commodities C having property information such as “ISBN is 1010, publication time is 2000-2010, hardcover bookbinding is adopted, price is 10-50” etc., and physics book commodities D having property information such as “ISBN is 1010, price is 10-50, publication time is 2000-2010” etc. The determined property information corresponding to the physics book commodity A, physics book commodity B, physics book commodities C and physics book commodities D under the product node M may be represented in table 1.

TABLE 1

| Commodity | | | | |
|---|---|---|---|---|
| type | Commodity property information | | | |
| Physics book | ISBN is | Publication | Author is B | Price is 10-50 |
| commodities | 1010 | time is 2000- | | |
| A | | 2010 | | |
| Physics book | ISBN is | Publication | Price is 10-50 | Hardcover |
| commodities | 1010 | time is 2000- | | bookbinding |
| B | | 2010 | | is adopted |
| Physics book | ISBN is | Publication | Hardcover | Price is 10-50 |
| commodities | 1010 | time is 2000- | bookbinding | |
| C | | 2010 | is adopted | |
| Physics book | ISBN is | Publication | Price is 10-50 | |
| commodities | 1010 | time is 2000- | | |
| D | | 2010 | | |

According to table 1, the final-determined property information corresponding to each commodity under the product node M is “ISBN is 1010”, “publication time is 2000-2010”, “author is B”, “price is 10-50,” and “hardcover bookbinding is adopted”.

Specifically, the final-determined properties corresponding to each commodity under the product node M are ISBN”, “publication time”, “author”, “price” and “bookbinding”, and corresponding property values of corresponding properties, i.e., ISBN”, “publication time”, “author”, “price” and “bookbinding” of each commodity under the product node M are “1010”, “2000-2010”, “B”, “10-50,” and “hardcover” respectively.

At 304, the computing device may determine whether property information to be updated exists in corresponding property information of each commodity under the product node. If so, the process 300 may advance to operation 306; otherwise, the process may advance to operation 316.

In some embodiments, the property information to be updated may be in corresponding property information of at least one commodity under the product node but not comprised in the current corresponding property information of the product node.

Turning back to the example of the product node M, the final determined property information corresponding to each commodity under the product node is “ISBN is 1010”, “publication time is 2000-2010”, “author is B”, “price is 10-50” and “hardcover bookbinding is adopted”, wherein “author is B”, “price is 10-50” and “hardcover bookbinding is adopted” that are included in corresponding property information of at least one commodity under the product node M but not included in the current corresponding property information, i.e., “ISBN is 1010” and “publication time is 2000-2010” of the product node M. Therefore, the property information, i.e., “author is B”, “price is 10-50” and “hardcover bookbinding is adopted” are the property information to be updated.

In addition, in the final determined corresponding properties, i.e., “ISBN”, “publication time”, “author”, “price” and “bookbinding” of each commodity under the product M, properties, i.e., “author”, “price” and “bookbinding” are included in corresponding property of at least one commodity under the product node M but not included in the current corresponding properties, i.e., “ISBN” and “publication time” of the product node M. Therefore, properties to be updated in the property information to be updated determined in the operation 304 are “author”, “price,” and “bookbinding.”

Likewise, in the final determined corresponding property values, i.e., “1010”, “2000-2010”, “B”, “10-50” and “hardcover” of corresponding properties, i.e., “ISBN”, “publication time”, “author”, “price” and “bookbinding” of each commodity under the product M, corresponding property values, i.e., “B”, “10-50” and “hardcover” of “author”, “price” and “bookbinding” are comprised in corresponding property of at least one commodity under the product node M but not comprised in the current corresponding properties of the product node M, so that the property values to be updated in the property information to be updated determined in operation 304 are corresponding property values, i.e., “B”, “10-50” and “hardcover” of “author”, “price” and “bookbinding”.

At 306, the computing device may determine whether the quantity of commodities of which corresponding property information includes the property information to be updated is larger than a first set threshold value. If so, the process 300 may advance to operation 308; otherwise the process 300 may advance to the operation 316.

In some embodiments, the first threshold value may be set according to practical situations. For example, if the navigation accuracy and required property navigation of commodities are high, the first threshold value may be set as a high numerical value. In some embodiments, the first threshold value may be the same as the value of the quantity of all commodities comprised under a product node to be updated. In these instances, the first threshold value may be less than or equal to the value of the quantity of all commodities comprised under the product node to be updated.

Turning back to the example of the product node M, the property information to be updated determined in the operation 304 is “author is B”, “price is 10-50” and “hardcover bookbinding is adopted.” Commodities of which corresponding property information comprises property information to be updated, i.e., “author is B” are physics book commodities A; commodities of which corresponding property information comprises property information to be updated, i.e., “price is 10-50” are physics book commodities A, physics book commodities B, physics book commodities C and physics book commodities D; and commodities of which corresponding property information comprises property information to be updated, i.e., “hardcover bookbinding is adopted” are physics book commodities B and physics book commodities D.

If the first set threshold value is the same as the value of the quantity of all commodities included under the product node M, the final obtained satisfactory property information to be updated is “price is 10-50”. Specifically, the final obtained satisfactory property is “price”, and the obtained corresponding property value to be updated of the property to be updated, i.e., “price” is “10-50”.

In these instances, the property information to be updated which is larger than the first set threshold value may be considered as important property information.

At 308, the computing device may add the property information to be updated into the current corresponding property information of the product node.

In some embodiments, after the operations of 304 and 306, the final obtained property information to be updated may be common property of a majority of commodities under the product node to be updated. Thus, the property information to be updated may be added into the product node to be updated.

Turning back to the example of the product node M, the property information to be updated, i.e., “price is 10-50” may be required to be added into corresponding property information of the product node M if the finally-obtained property information to be updated that satisfies the first set threshold value is “price is 10-50.”

Specifically, the property to be updated, i.e., “price” in the property information to be updated, i.e., “price is 10-50” and the corresponding property value to be updated, i.e., “10-50” of the property to be updated, i.e., “price” may be required to be added into corresponding properties and property values of the product node M.

At 310, the computing device may perform commodity property navigation by using the current corresponding property information of the updated product node.

In some embodiments, each product node, corresponding property information of each product node, each commodity and corresponding property information of each commodity have a piece of identifier (ID) information for representing IDs specific to the aim of distinguishing each product node, corresponding property information of each product node, each commodity, and corresponding property information of each commodity. In some instances, the product ID of a product represented by each product node and corresponding property information and property information ID of each product node may be saved in the product information database, and each commodity ID and corresponding property information and property information ID of each commodity may be saved in the commodity information database. One or more product information databases are available, and one or more commodity information databases are also available. The embodiment of the disclosure does not make any limitation on this aspect. Moreover, each commodity under the same product node and the product node may have the same product ID.

In some embodiments, property information may include properties and property values so that corresponding property and property value of each product node and corresponding property and property value of each commodity are provided with an ID for representing identities thereof respectively specific to the aim of distinguishing each property and property value respectively.

Turning back to the example of the product node M, the physic book commodities A, B, C and D under the product node M have the same product ID (product 11) if the product ID corresponding to the product node M is product 01.

Specifically, the product property ID of the property “ISBN” in the corresponding property information of the product node M before updating may be product property 01, and the product property ID of the property “publication time” in the corresponding property information of the product node M before updating may be product property 02; and the product property value ID of the corresponding property value “A” of the property “ISBN” in the corresponding property information of the product node M before updating may be product property value 01, and corresponding property value ID of corresponding property value “2000˜2010” of the property “publication time” in the corresponding property information of the product node M before updating may be product property value 02.

In some embodiments, corresponding property and property value of each commodity under the product node M may also have a unique ID respectively. For example, the property ID of corresponding property “ISBN” of each commodity under the product node M may be commodity property 01, the property ID of “publication time” may be commodity property 02, the property ID of “author” may be commodity property 03, the property ID of “price” may be commodity property 04, and the property ID of “bookbinding” may be commodity property 05. Likewise, corresponding property values “1010”, “2000-2010”, “B”, “10-50” and “hardcover” of corresponding properties “ISBN”, “publication time”, “author”, “price” and “bookbinding” of each commodity under the product node M have a unique ID respectively.

In some embodiments, the property information to be updated may be renamed when the property information to be updated is added into corresponding property information of the product node to be updated so as to obtain property information which is up to practical standard. Turning back to the example of the product node M, the property information to be updated, i.e., “price is 10-50” may be renamed as “the price is RMB 10-50 Yuan” when the property information to be updated, i.e., “price is 10-50” is added into corresponding property information of the product node M. In some instances, the property value “10-50” of the property information to be updated, i.e., “price is 10-50” may be required to be updated into “RMB 10-50 Yuan”. Correspondingly, the product property ID and product property value ID of the property information ID to be updated may be further required to be edited when the property information to be updated is added into corresponding property information of the product node to be updated. For example, the product property ID of the property “price” may be edited as product property 03, and the product property value ID of the product value “RMB 10-50 Yuan” may be edited as product property value 03.

Furthermore, the computing device may add the property information to be updated that is larger than the first set threshold value into the commodity information database after the property information to be updated that is larger than the first set threshold value is added into current corresponding property information of the product node and before commodity property navigation is performed by using the current corresponding property information of the updated product node.

In some embodiments, the computing device may perform operations when the property information to be updated which is larger than the first set threshold value is added into the commodity information database. The operations may include re-editing the IDs (including property ID and property value ID) of the property information to be updated that is larger than the first set threshold value, performing a renaming operation on the property information to be updated (including properties and property values) that is larger than the first set threshold value, and adding the re-edited and renamed property information to be updated that is larger than the first set threshold value into the commodity information database. In some instances, the computing may take the product property name and the product property value name of the property information to be updated in the product information database as the commodity property name and commodity property value name of the re-edited property information to be updated in the commodity information database.

Turning back to the example of the product node M, the property “price” and property value “10-50” in the property information to be updated, i.e., “price is 10-50” may be also required to edit commodity property ID and commodity property value ID so as to prevent conflict with the commodity property ID and commodity property value ID in the original commodity information database after the obtained property information to be updated, i.e., “price is 10-50”, that is larger than the first set threshold value is added into corresponding property information of the product node M and the added property information to be updated, i.e., “price is 10-50” is renamed as “the price is RMB 10-50 Yuan.” Moreover, the commodity property and commodity property value of the re-edited and renamed property information to be updated may be added into the commodity information database by taking the property name “price” and property value name “RMB 10-50 Yuan” of the property information to be updated, i.e., “the price is RMB 10-50 Yuan” in the product information database as the commodity property name and commodity property value name of the edited property information to be updated respectively.

In some embodiments, the computing device may ensure that the edited commodity property ID and the commodity property value ID is non-repetitive to the commodity property ID and the commodity property value ID in the non-updated commodity information database during re-edition of the commodity property ID and the commodity property value ID for the property information to be updated. In some instances, the maximum value of the commodity property ID (or commodity property value ID) in the non-updated commodity property table may be amplified by 1-10 times, and the non-occupied commodity property ID (or commodity property value ID) in the amplified commodity property ID (or commodity property value ID) may be taken as the commodity property ID (or commodity property value ID) of the property information to be updated.

After the abovementioned operations are performed, the current corresponding property information of the updated product node M may be more specific, and more efficient commodity property navigation may be provided for users, and the user experience is improved, when the current corresponding property information, i.e., “ISBN is 1010”, “publication time is 2000-2010” and “price is 10-50” of the updated product node M is compared with the property information, i.e., “ISBN is 1010” and “publication time is 2000-2010” before updating.

At 312, the computing device may determine times that navigation has been performed by taking each piece of corresponding property information of the updated product node as a keyword in set duration.

In some embodiments, the computing device may update user search click log according to corresponding property information of the updated product node (i.e., newly-added property information is added into an original user search click log) and calculate corresponding click situation of each piece of property information, i.e., count the times when navigation is performed by taking each piece of corresponding property information of the updated product node as a keyword in set duration.

In some embodiments, the computing device may update a user search click log according to properties and corresponding property values of the properties comprised in corresponding property information of the updated product node, and calculate corresponding click situations of each property and the corresponding property value of each property.

At 314, the computing device may perform commodity property navigation by taking property information of which the navigation times are larger than a second set threshold value as the current corresponding property information of the product node.

In 310, the problem of a small quantity of times of navigation performed by taking certain property information as a keyword may exist when commodity navigation is performed by using corresponding property information of the updated product node. Therefore, at 314, the computing device may continue commodity property navigation by taking property information of which the navigation times are larger than a set threshold value as the current corresponding property information of the product node according to the times of navigation performed by taking each piece of corresponding property information of the updated product node determined at 312 as a keyword. The computing device may also perform a second determination using the property information of the commodity property navigation, and property information that is taken as a keyword for navigation for a large quantity of times is taken as final needed property information.

In some embodiments, the second threshold value may be set according to practical situation. In order to increase the accuracy of commodity property navigation and achieve higher consistency with the practical use requirements of users, the second threshold value may be set as a high numerical value. No limitation is made in the embodiment of the disclosure.

At 316, the computing device may determine whether a product node that does not undergo judgment on the presence of property information to be updated still exists in the current product information database. If so, the process 300 may advance to 302; otherwise, the process 300 may end the operation at 318.

Corresponding property information of each commodity in the related commodity information database may be generally acquired by the following two measures in the operating processes from operations 302 and 316.

First, the measure I may include acquiring commodity property information by adopting a Feed way. In this measure, the integrity and accuracy of obtained commodity property information are high since filling or entering of commodity property information may be performed by the commodity supplier; however, the property information of a part of commodities may be still filled incorrectly possibly since the commodity supplier enters commodity property information manually. Turning back to the example of the product node M, the product node M may include physics book commodities E and the practical property information of the physics book commodities E is “ISBN is 1010, publication time is 2000-2010, price is 10-50, hardcover bookbinding is adopted, and author is B”, the “author B” is incorrectly entered as “author A” when commodity information is entered by the commodity supplier manually. Thus, incorrect commodity property information may exist in final obtained corresponding property information of the product node M, and the correctness of the property information of the physics book commodities E may be influenced.

Second, the measure II may include acquiring commodity property information by adopting a Crawl way. In this measure, commodity information may be crawled from each Internet website, and property information blocks may be extracted automatically from the crawled commodity information according to a pre-configured property information template so as to obtain commodity property information. In some embodiments, webpage formats of each Internet website are not uniform, and JavaScript phenomenon exists. Thus, only a small part of commodity property information may be obtained in this measure, leading to non-integrity associated with the obtained commodity property information and to possibility of format error. For example, turning back to the example of the product node M, suppose that the product node M further includes physics book commodities E and the practical property information of the physics book commodities E is “ISBN is 1010, publication time is 2000-2010, price is 10-50, hardcover bookbinding is adopted, and author is B.” The property information such as “price is 10-50, hardcover bookbinding is adopted, and author is B”, etc. may be missed when property information of the physics book commodities E is crawled from an Internet webpage A by adopting the Crawl way if the property information such as “price is 10-50, hardcover bookbinding is adopted, and author is B”, etc. in the webpage A is inconsistent with the preset template. Thus, the integrity of property information of the physics book commodities E may be influenced.

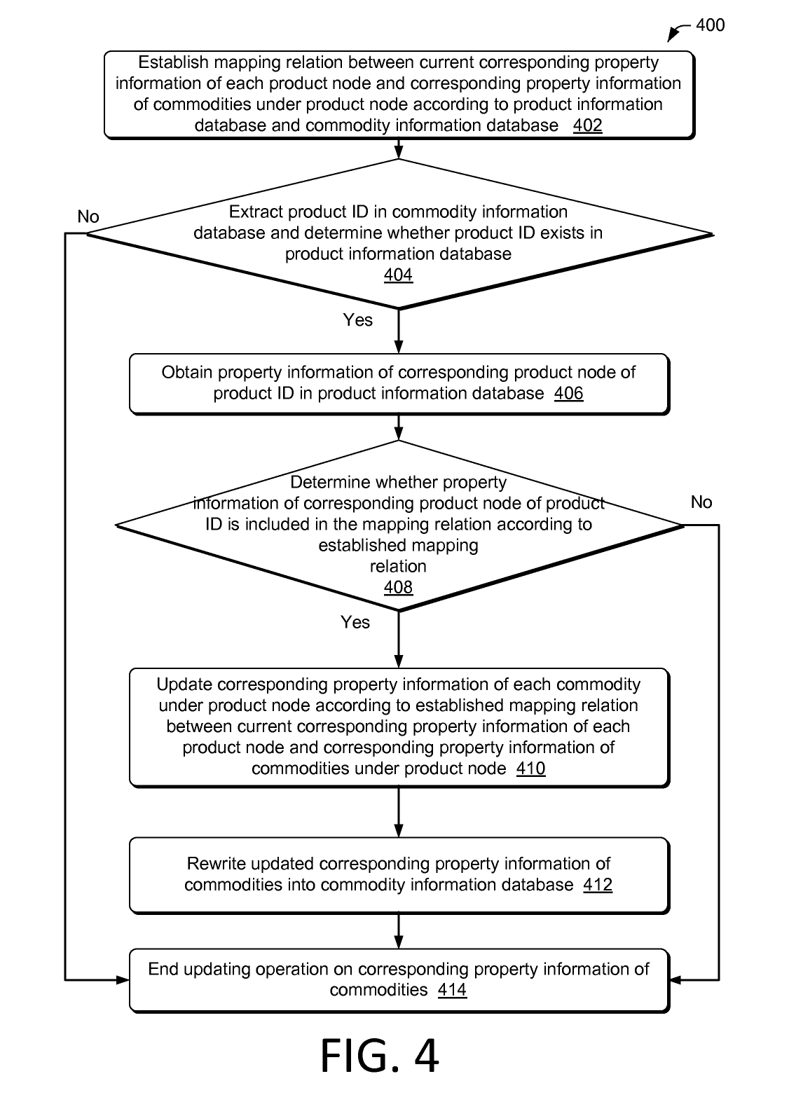

In some embodiments, the currently-obtained corresponding property information of each commodity may not be necessarily integral or accurate to enrich and perfect the commodity information of commodities. The obtained corresponding property information of each commodity may also be required to be subjected to updating operation such as supplement, correction and the like in the method for realizing commodity property navigation in the embodiment 1 of the disclosure. As illustrated in FIG. 4, the specific operation flow for updating corresponding property information of the commodity may include the following operations.

At 402, the computing device may establish a mapping relation between the current corresponding property information of each product node and the corresponding property information of commodities under the product node according to corresponding property information of each product node in the product information database and corresponding property information of each commodity in the commodity information database.

The property information may include properties and property values, so that the established mapping relation between the current corresponding property information of each product node and the corresponding property information of commodities under the product node may include property mapping relation and property value mapping relation.

In some embodiments, the property mapping relation may be established by determining corresponding single value property of a category to which the product node in a product information table belongs according to a product category property value table and determining all corresponding properties of the category to which the product node belongs according to a commodity category property value table.

In some embodiments, the properties may include single value properties and non-single-value properties. The single value properties mean corresponding property values of the properties of the same type of commodities, and the values are unique. For example, by taking the properties “publisher” of physics book commodities as an example, only the property value “A” exists under the properties “publisher” of the same type of commodities clustered by using physics book commodities A, B, C, D, etc., indicating that the properties “publisher” are single value properties. If other property values such as “B” or “C”, etc. also exist under the properties “publisher” of the same type of commodities (for example, the publisher of physics book commodities A is A while the publisher of physics book commodities B is B), the properties “publisher” are non-single-value properties.

In some embodiments, the product category property value may include information such as corresponding category, property, property value, etc. of each product; and the product information table may include information such as the product ID of each product, corresponding property and property value of the product, etc.

In some embodiments, for any corresponding determined single value property of the product node, the computing device may determine whether the single value property and any corresponding single value property of a commodity under the product node belong to the same category and the property names are the same or synonymous. If so, the computing device may establish a property mapping relation between the single value property of the product node and the corresponding single value property of the commodity under the product node. The computing device may continue the abovementioned determination operation for other corresponding single value properties of the product node until the decision operation is finished on each corresponding single value property of the product node so as to obtain a property mapping relation between products represented by the product node and commodities under the product node.

In some embodiments, the determined corresponding single value properties of the product node or the corresponding properties of commodities under the product node may be properties that are determined by operation.

In some embodiments, suppose that the determined corresponding single value properties of the product node M under the “physics” category comprise “author”, “publisher”, “ISBN” and “publication time” and the determined corresponding properties of the commodities under the “physics” category are “author”, “ISBN”, “publisher” and “bookbinding.” The single value properties “author” and the corresponding properties “author” of commodities belong to the same category, and the property names are the same. Thus, it may be considered that a property mapping relation may be established between the single property “author” of the product node and the corresponding properties “author” of commodities under the product node.

In some embodiments, the single value properties “publisher” and corresponding properties “publisher” of commodities belong to the same category, and the property names are synonymous. Thus, it may be considered that a property mapping relation may be established between the single value property “publisher” of the product node and corresponding properties “publisher” of commodities under the product node.

In some embodiments, the computing device may correct the property mapping relation between the product and the commodities by adopting a manual reviewing way. The mapping relation obtained by adopting the manual reviewing way may be taken as a basis if a conflict exists between the mapping relation obtained by adopting the manual reviewing way and a mapping relation obtained by adopting the abovementioned way.

In some instances, the property value mapping relation may be established in the following way. Suppose that corresponding property values of single value properties in the current corresponding property information of a product node and corresponding property values of single value properties in corresponding property information of commodities under the product node belong to the same category and the same property, and the property value names are the same or synonymous. As results, the computing device may establish a property value mapping relation between corresponding property value of single value property of the product node and corresponding property values of corresponding single value properties of commodities under the product node.

In some embodiments, the computing device may determine whether the property values of the product and the property values of the commodities are the same or synonymous or not under the same category and the properties of the same name on the basis of the established property mapping relation. If so, the computing device may establish a property value mapping relation between the property values of the product and the property values of corresponding commodities. Moreover, for a part of product property values of which corresponding relation cannot be found by adopting the text matching method, corresponding product properties of the property values of the product may be required to be searched under the same product ID. Suppose that the product property under the product ID corresponds to a plurality of commodities, and corresponding commodity properties in the commodity information table exist in the property mapping relation between the product and the commodities. As results, it is considered that the product property values may be mapped onto corresponding commodity property values.

Furthermore, after the property value mapping relation is established, the computing device may correct the property mapping relation between the product and the commodities by adopting a manual reviewing way. The mapping relation obtained by adopting the manual reviewing way may be taken as a basis if a conflict exists between the mapping relation obtained by adopting the manual reviewing way and a mapping relation obtained by adopting the abovementioned way.

At 404, the computing device may extract the product ID in the commodity information database, judging whether the product ID exists in the product information database. If so, the process 400 may advance to operation 406; otherwise, the process 400 may advance to operation 414.

In some embodiments, the computing device may search whether the product ID exists in the product information database according to the product ID in the commodity information database. If not, a commodity is not provided with any product node, and supplement and correction of the property information (including properties and property values) of the commodity may not be performed.

At 406, the computing device may acquire product information of corresponding product node of the product ID in the product information database.

In some embodiments, the computing device may acquire the property information including properties and property values of corresponding product node of the product ID in the product information database according to the product ID searched from the product information database.

At 408, the computing device may determine, for any product node, whether the property information of corresponding product node of the product ID is included in the mapping relation according to the established mapping relation between the current corresponding property information of the product node and corresponding property information of commodities under the product node. If so, the process 400 may advance to the operation 410; otherwise, the process 400 may advance to 414.

At 410, the computing device may update corresponding property information of each commodity under the product node according to the established mapping relation between the current corresponding property information of the product node and corresponding property information of each commodity under the product node.

In some embodiments, the computing device may supplement the single value properties and corresponding property values of the product node that the product node lacks in corresponding properties of the commodities under the product node according to the established property mapping relation between the single value properties of the product node and the corresponding single value properties of the commodities under the product node. The computing device may then correct property values that are inconsistent with the property values of the product node in corresponding property values of the commodities under the product node.

In some embodiments, the product node may be a product clustered by using the category and key properties of the same type of commodities so that corresponding property value of the single value property of each commodity under the product node may be identical. In some embodiments, corresponding property values of certain non-single-value properties may be different in corresponding properties and property values of the commodities under the product node. Meanwhile, the established mapping relation (including property mapping relation and property value mapping relation) between the current corresponding property information of the product node and the corresponding property information of commodities under the product node may be based on corresponding single value properties of the product node. Thus, property information that does not exist in the commodities under the product node may be supplemented, and the property information of commodities with certain problems may be corrected under the product node according to the established mapping relation (including property mapping relation and property value mapping relation) between the current corresponding property information of the product node and the corresponding property information of commodities under the product node in the scheme of the embodiment of the disclosure. Therefore, the effects of improving the integrity and correctness of corresponding property information of commodities may be achieved.

At 412, the computing device may rewrite corresponding updated property information of commodities into the commodity information database.

In some embodiments, the computing device may delete non-updated property information (property information of original commodities which are subjected to updating operation such as correction or supplement, etc.), and rewrite corresponding updated (including correction or supplement) property information of commodities into the commodity information database.

At 414, the computing device may end the updating operation performed on corresponding property information of commodities.

In some embodiments, the data size included in the related product information database, commodity information database, etc. in the embodiment of the disclosure is huge. Thus, the method for realizing commodity property navigation and the method for updating commodity property information disclosed by the embodiment of the disclosure may be implemented by adopting a cloud computing platform.

Embodiments of the disclosure provide methods for commodity property navigation. In some embodiments, the computing device may add the property information to be updated into the current corresponding property information of the product node, and perform commodity property navigation by using the current corresponding property information of the updated product node, wherein the property information to be updated is comprised in corresponding property information of at least one commodity under the product node but not comprised in the current corresponding property information of the product node when property information to be updated exists in corresponding property information of each commodity under any product node in the product information database. Via the technical scheme of the embodiments of the disclosure, mining and navigation of novel commodity properties may be realized automatically, and the problem of poor navigation efficiency caused by non-prompt commodity novel property update during determination of commodity navigation and property navigation by adopting a manual reviewing way existing in the prior art may be solved. Meanwhile, the embodiments of the disclosure further provide a method for performing updating operation such as supplement, correction, etc. on corresponding acquired property information of each commodity so as to improve the integrity and correctness of the acquired property information of the commodities.

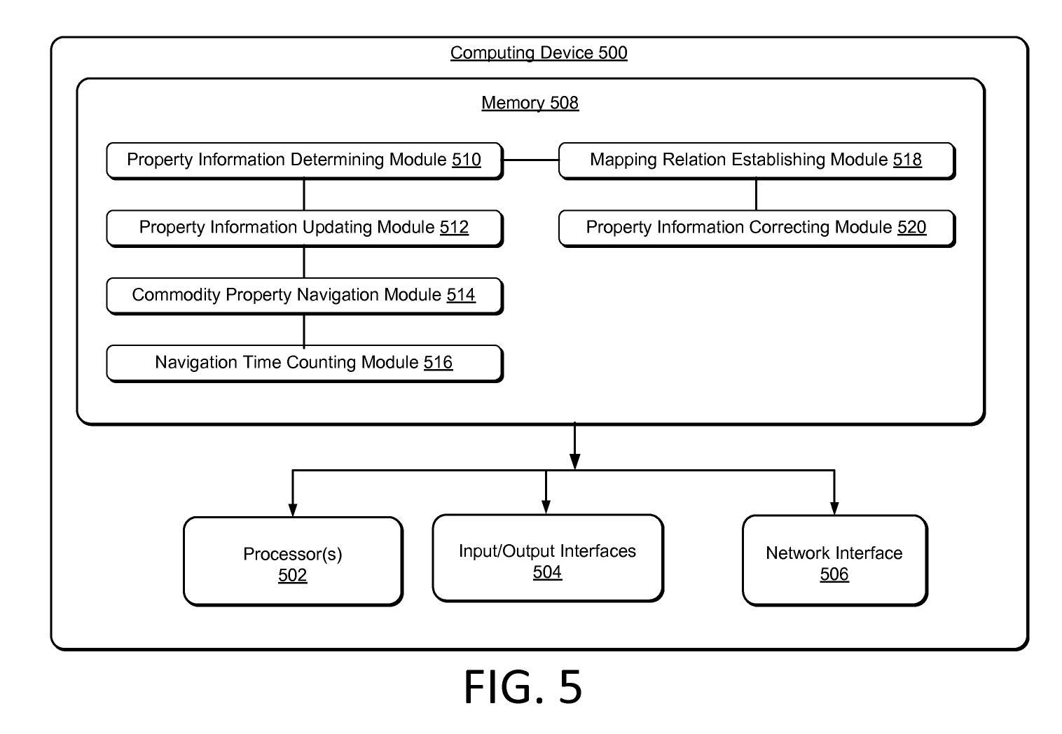

FIG. 5 is a schematic diagram of an illustrative computing architecture that enables commodity navigation. FIG. 5 is a diagram of a computing device 500. The computing device 500 may be a user device or a server for a multiple location login control. In one exemplary configuration, the computing device 500 includes one or more processors 502, input/output interfaces 504, network interface 506, and memory 508.

The memory 508 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 508 in more detail, the memory 508 may include a property information determining module 510, a property information updating module 512, and a commodity property navigation module 514.

The property information determining module 510 is configured to determine, for any product node in a product information database, current corresponding property information of the product node and corresponding property information of each commodity under the product node. In some embodiments, the product node may be obtained by clustering commodities belonging to the same category and having the same key property information according to key property information in corresponding property information of each commodity in the commodity information database and a category to which corresponding property information of each commodity belongs. In some embodiments, the key property information may include property information capable of identifying commodity characteristics. For any product node, corresponding property information (such as key property information) of the product node may reflect shared information of the same type of commodities. In some embodiments, the property information comprises properties and property values. For a product node, corresponding property information of the product node may include the properties of the product node and property values of the product node corresponding to the properties of the product node. For any commodity, the property information of the commodity may include the property of the commodity and the property value of the commodity corresponding to the property of the commodity.

In some embodiments, corresponding property information of each commodity in the commodity information database may be generally acquired by adopting the following two ways. First, the computing device may acquire commodity property information by adopting a Feed way. In some instances, filling or entering of commodity property information may be performed by the commodity supplier. The integrity and accuracy of the obtained commodity property information may be high. Second, the computing device may acquire commodity property information by adopting a Crawl way. In some embodiments, commodity property information may be obtained by crawling commodity information from each Internet website and automatically extracting property information from crawled commodity information according to a pre-configured property information template. Compared with first measure, the integrity and accuracy of the obtained commodity property information associate with the second measure may be lower.

The property information updating module 512 is configured to add the property information to be updated into the current corresponding property information of the product node when property information to be updated exists. In some embodiments, the property information to be updated may be included in corresponding property information of at least one commodity under the product node but not comprised in the current corresponding property information of the product node.

In some embodiments, the property information updating module 512 is configured to add the property information to be updated into the current corresponding property information of the product node when property information to be updated exists and the quantity of commodities of which corresponding property information comprises the property information to be updated is larger than a first set threshold value. The first threshold value may be set as a high numerical value. For example, the first threshold value may be set as a high numerical value if the navigation accuracy of commodity property navigation required to be performed is high. In some embodiments, the first threshold value may be the same as the value of the quantity of all commodities comprised under the product node to be updated; furthermore. The property information to be updated may be renamed when the property information to be updated may be added into corresponding property information of the product node to be updated so as to obtain property information that depends on practical standards.

The commodity property navigation module 514 is configured to perform commodity property navigation by using the current corresponding property information of the updated product node.

Furthermore, the memory 508 may also include a navigation time counting module 516.

The navigation time counting module 516 is configured to count the times when navigation is performed by taking each piece of corresponding property information as a keyword in set duration of commodity property navigation performed by using the current corresponding property information of the updated product node via the commodity property navigation module 516;

In some embodiments, the commodity property navigation module 516 is configured to continue commodity property navigation by taking property information of which the navigation times are larger than a second set threshold value as the current corresponding property information of the product node. In some instances, the second threshold value may be set according to practical situation. To increase the accuracy of commodity property navigation and achieve higher consistence with the practical use requirements of users, the second threshold value may be set as a high numerical value.

Furthermore, the memory 508 may also include a mapping relation establishing module 518

The mapping relation establishing module 518 is configured to establish a mapping relation between the current corresponding property information of each product node and the corresponding property information of commodities under the product node according to corresponding property information of each product node in the product information database and corresponding property information of each commodity in the commodity information database. In some embodiments, the mapping relation establishing module 518 is configured to establish a property mapping relation between the single value properties of the product node and the corresponding single value properties of the commodities under the product node when single value properties in the current corresponding property information of the product node and the single value properties in the corresponding property information of the commodities under the product node belong to the same category and the property names are the same or synonymous. The mapping relation establishing module 518 may establish a property value mapping relation between the corresponding property values of single value properties of the product node and corresponding property values of corresponding single value properties of the commodities under the product node when the corresponding property values of single value properties in the current corresponding property information of the product node and corresponding property values of corresponding property values of single value properties in corresponding property information of the commodities under the product node belong to the same category and the same property and the property value names are the same or synonymous.

Furthermore, the memory 508 may also include a property information correcting module 520.

The property information correcting module 520 is configured to update corresponding property information of each commodity under the product node according to the mapping relation between the current corresponding property information of the product node and corresponding property information of each commodity under the product node established by the mapping relation establishing module 518 for any product node. In some embodiments, the property information correcting module 520 may supplement corresponding single value properties and corresponding property values of the product node lacked in corresponding property information of the commodities under the product node according to the established property mapping relation between the single value properties of the product node and the corresponding single value properties of the commodities under the product node. The property information correcting module 520 may correct property values that are inconsistent with the property values of the product node in corresponding property values of the commodities under the product node according to the established property value mapping relation between corresponding property values of the single value properties of the product node and corresponding property values of the single value properties of commodities under the product node.

In some embodiments, the product node may be a product clustered by using the category and key properties of the same type of commodities so that corresponding property value of the single value property of each commodity under the product node may be identical. In some embodiments, corresponding property values of certain non-single-value properties may be different in corresponding properties and property values of the commodities under the product node in the embodiments of the disclosure. Meanwhile, the established mapping relation (including property mapping relation and property value mapping relation) between the current corresponding property information of the product node and the corresponding property information of commodities under the product node may be based on corresponding single value properties of the product node. Thus, property information which does not exist in the commodities under the product node may be supplemented. In addition, the property information of commodities with certain problems under the product node may be corrected according to the established mapping relation (including property mapping relation and property value mapping relation) between the current corresponding property information of the product node and the corresponding property information of commodities under the product node in the scheme of the embodiments of the disclosure. Therefore, the integrity and correctness of corresponding property information of commodities may be improved.

The above describes only preferred embodiments of the present disclosure. Apparently, the skilled in the art is allowed to make various modifications and changes on the disclosure without departing from the spirit or scope of the disclosure. Accordingly, the disclosure intends to include those modifications and changes once these modifications and changes belong to the scope of the claims of the disclosure and equal technology.

What is claimed is:

1. A computer-implemented method for commodity property navigation, the method comprising:
determining property information corresponding to a product node in a product information database and property information corresponding to commodities under the product node, the product node being obtained by grouping commodities that belong to a category and have key property information;
determining that the property information corresponding to the product node does not include property information to be updated corresponding to one or more commodities under the product node;
adding the property information to be updated into the property information corresponding to the product node to generate an updated property information of the product node; and
performing a commodity property navigation by using the property information of the product node.

2. The method of claim 1, wherein the adding the property information to be updated into the property information corresponding to the product node to generate the updated property information of the product node comprises:
in response to the determining that the property information corresponding to the product node does not include property information to be updated corresponding to one or more commodities under the product node and a number of the one or more commodities is greater than a predetermined value, the adding the property information to be updated into the property information corresponding to the product node to generate the updated property information of the product node.

3. The method of claim 1, further comprising:
determining a number of times that the commodity property navigation has been performed in a predetermined time period using individual pieces of the updated property information of the product node as a key word;
determining one or more pieces of the updated property information that have the number greater than one predetermined value; and
performing an addition commodity property navigation using the one or more pieces of the update property information of the product node.

4. The method of claim 1, further comprising:
establishing a mapping relation between property information of each product node and property information of commodities corresponding to the each product node according to a product information database and a commodity information database; and
updating the property information of commodities corresponding to the each product node for the each product node based on the established mapping relation.

5. The method of claim 4, wherein the property information comprises properties and property values, and the properties comprise single value properties and non-single-value properties.

6. The method of claim 5, wherein the establishing the mapping relation comprising:
establishing a property mapping relation between a single value property of one product node and a single value property of commodities under the one product node if the single value property of one product node and a single value property of commodities under the one product node belong to one category and have a same or synonymous property name; and
establishing a property value mapping relation between a single property value of one product node and a single property value of commodities under the one product node if the single property value of one product node and a single property value of commodities under the one product node belong to one category and have a same or synonymous property name.

7. The method of claim 6, wherein the updating the property information of commodities corresponding to the each produce node for the each product node based on the established mapping relation comprises:
complementing one single value property and a corresponding property value of the one product node that do not exist in corresponding property information of commodities under the one product node based on the property mapping relation; and
correcting property values in property values of commodities under the product node that are inconsistent with property values of the one product node based on the property value mapping relation.

8. A system for commodity property navigation, the system comprising:
one or more processors; and
memory to maintain a plurality of components executable by the one or more processors, the plurality of components comprising:
a property information determining module configured to:
determine property information corresponding to a product node in a product information database and property information corresponding to commodities under the product node, the product node being obtained by grouping commodities that belong to a category and have key property information, and
determine that the property information corresponding to the product node does not include property information to be updated corresponding to one or more commodities under the product node,
a property information updating module configured to add the property information to be updated into the property information corresponding to the produce node to generate an updated property information of the product node, and
a commodity property navigation module configured to perform a commodity property navigation by using the property information of the product node.

9. The system of claim 8, wherein the adding the property information to be updated into the property information corresponding to the product node to generate the updated property information of the product node comprises:
in response to the determining that the property information corresponding to the product node does not include property information to be updated corresponding to one or more commodities under the product node and a number of the one or more commodities is greater than a predetermined value, the adding the property information to be updated into the property information corresponding to the product node to generate the updated property information of the product node.

10. The system of claim 8, wherein the plurality of components further comprises:
a navigation time counting module configured to:
determine a number that the commodity property navigation has been performed in a predetermined time period using individual pieces of the updated property information of the product node as a key word; and
determine one or more pieces of the updated property information that have the number greater than one predetermined value; and
a commodity property navigation module configured to perform an addition commodity property navigation using the one or more pieces of the update property information of the product node.

11. The system of claim 8, wherein the plurality of components further comprise:
a mapping relation establishing module configured to establish a mapping relation between property information of each product node and property information of commodities corresponding to the each product node according to a product information database and a commodity information database, and
a property information correcting module configured to update the property information of commodities corresponding to the each product node for the each product node based on the established mapping relation.

12. The system of claim 11, wherein the property information comprises properties and property values, and the properties comprise single value properties and non-single-value properties.

13. The system of claim 12, wherein the establishing the mapping relation comprising:
establishing a property mapping relation between a single value property of one product node and a single value property of commodities under the one product node if the single value property of one product node and a single value property of commodities under the one product node belong to one category and have a same or synonymous property name; and
establishing a property value mapping relation between a single property value of one product node and a single property value of commodities under the one product node if the single property value of one product node and a single property value of commodities under the one product node belong to one category and have a same or synonymous property name.

14. The system of claim 12, wherein the updating the property information of commodities corresponding to each product node for each product node based on the established mapping relation comprises:
complementing one single value property and a corresponding property value of the one product node that do not exist in corresponding property information of commodities under the one product node based on the property mapping relation; and
correcting property values in property values of commodities under the one? product node that are inconsistent with property values of the one product node based on the property value mapping relation.

15. One or more computer-readable media storing computer-executable instructions that, when executed by one or more processors, instruct the one or more processors to perform acts comprising:
determining property information corresponding to a product node in a product information database and property information corresponding to commodities under the product node, the product node being obtained by grouping commodities that belong to a category and have key property information;
determining that the property information corresponding to the product node does not include property information to be updated corresponding to one or more commodities under the product node;
adding the property information to be updated into the property information corresponding to the product node to generate a updated property information of the product node; and
performing a commodity property navigation by using the property information of the product node.

16. The one or more computer-readable media of claim 15, wherein the adding the property information to be updated into the property information corresponding to the product node to generate the updated property information of the product node comprises:
in response to the determining that the property information corresponding to the product node does not include property information to be updated corresponding to one or more commodities under the product node and a number of the one or more commodities is greater than a predetermined value, the adding the property information to be updated into the property information corresponding to the product node to generate the updated property information of the product node.

17. The one or more computer-readable media of claim 15, wherein the acts further comprise:
determining a number of times that the commodity property navigation has been performed in a predetermined time period using individual pieces of the updated property information of the product node as a key word;
determining one or more pieces of the updated property information that have the number greater than one predetermined value; and
performing an addition commodity property navigation using the one or more pieces of the update property information of the product node.

18. The one or more computer-readable media of claim 15, wherein the acts further comprise:
establishing a mapping relation between property information of each product node and property information of commodities corresponding to each product node according to a product information database and a commodity information database; and
updating the property information of commodities corresponding to each product node for each product node based on the established mapping relation.

19. The one or more computer-readable media of claim 18, wherein the property information comprises properties and property values, and the properties comprise single value properties and non-single-value properties.

20. The one or more computer-readable media of claim 19, wherein the establishing the mapping relation comprising:
establishing a property mapping relation between a single value property of one product node and a single value property of commodities under the one product node if the single value property of one product node and a single value property of commodities under the one product node belong to one category and have a same or synonymous property name; and
establishing a property value mapping relation between a single property value of one product node and a single property value of commodities under the one product node if the single property value of one product node and a single property value of commodities under the one product node belong to one category and have a same or synonymous property name.
